(19) United States
(12) Patent Application Publication
(10) Pub. No.: US 2015/0199737 A1
(43) Pub. Date: Jul. 16, 2015

(54) Method for Selling Electronic Books

(71) Applicant: Jie Chen, Land O Lakes, FL (US)

(72) Inventor: Jie Chen, Land O Lakes, FL (US)

(21) Appl. No.: 14/277,424

(22) Filed: May 14, 2014

Related U.S. Application Data
(60) Provisional application No. 61/927,700, filed on Jan. 15, 2014.

(51) Int. Cl. G06Q 30/06; G06Q 30/02

(52) U.S. Cl. CPC G06Q 30/0601; G06Q 30/0283

(57) ABSTRACT

A method of selling a plurality of books through a website is executed through a plurality of free chapters and a plurality of buyable chapter of each of the books, where the user account can select a specific book from the books. While the free chapters are displayed to the user account without any payment, the user accounts have to pay a variable fee for each of the buyable chapters, where the variable fee is calculated with a word count and a predetermined price. A price index of the specific book is calculated in order to compute a final price for the specific book along with the variable fees for each of the buyable chapters. The final price credits a refund to the user account of the specific book, if the total variable fee for each of the payable chapters is higher than the final price.

The current application claims a priority to the U.S. Provisional Patent application Ser. No. 61/927,700 filed on Jan. 15, 2014.

### FIELD OF THE INVENTION

The present invention relates generally to the field of online merchandising. More specifically, the present invention is a website that allows authors/owners to start selling their electronic books before the electronic books are completely finished.

### BACKGROUND OF THE INVENTION

Authors who write books, code, etc. generally sell their products via paper publishing or online publishing. Although paper publishing used to be the traditional way to sell written materials, online publishing has been getting more attention from general readers due to advancements in computer technology. Whether it is paper publishing or online publishing, readers normally have to buy the completed materials for a fixed price. There could be adjustments on the fixed price, such as discounts, but these adjustments are mainly based on sales condition only. Additionally, the fixed price for the completed materials can be increased due to other additional charges that include but are not limited to, overhead cost, publishing cost, and marketing cost.

Therefore it is an object of the present invention to allow online publishing for authors so that their work can be published as sections. More specifically, the authors can publish their work as small sections or chapters without having to wait for them to be finished. This method allows the authors to sell each section at a time with a much lower price. Since nothing is finalized, authors get to revise, correct, and add more material during the process of writing. Readers also get to enjoy the written materials as they get published through the present invention, where the published material can be free of charge or comprises a fee. At the end of the publication, multiple parameters determine an index number for the material so that the final pricing can be calculated according the index number.

### BRIEF DESCRIPTION OF THE DRAWINGS

FIG. 1 is a basic flowchart of the present invention, showing the process of selecting either the chapter feature, the donation feature, or the vote feature.

FIG. 2 is a basic flowchart of the present invention, showing the process of selecting the chapter feature by the user account.

FIG. 3 is a basic flowchart of the present invention, showing the process of calculating the refund within the chapter feature by the user account.

FIG. 4 is a basic flowchart of the present invention, showing the process of selecting the donation feature by the user account.

FIG. 5 is a basic flowchart of the present invention, showing the process of selecting the vote feature by the user account.

FIG. 6 is a basic flowchart of the present invention, showing the process of calculating the price index.

FIG. 7 is a basic flowchart of the present invention, showing the process of uploading the new book by the author account.

### DETAIL DESCRIPTIONS OF THE INVENTION

All illustrations of the drawings are for the purpose of describing selected versions of the present invention and are not intended to limit the scope of the present invention.

The present invention is a method of selling electronic books through an online platform. A library of books of the present invention can be accessed by a user account, where each of the libraries of books includes a book profile, a price index, a plurality of free chapters, and a plurality of buyable chapters. Even though the present invention is hereinafter explained in relation to the user account, the same process can be executed through other user accounts. The present invention allows the user account to individually purchase each chapter of the library of books without having to purchase the whole book, and also allows the authors to publish their written material in sections or chapters before finishing the completed version of the book.

In order for a user to access the present invention, the user of the present invention needs to create the user account through the sign-up process of the present invention so that the control software can grant access into the present invention. In order to create the user account, the user needs to provide a user name, a password, and a user email. Then the user account can access the present invention through the user name and the password. Additionally, the user may also access the present invention through an existing social network profile, where the user does not have to provide the user name or the password. Once the user account is created within the present invention, the user can modify and update the password and other user profile information in order to complete the user account, where the other user profile information of the user account includes features such as, uploading an avatar and setting up a payment account.

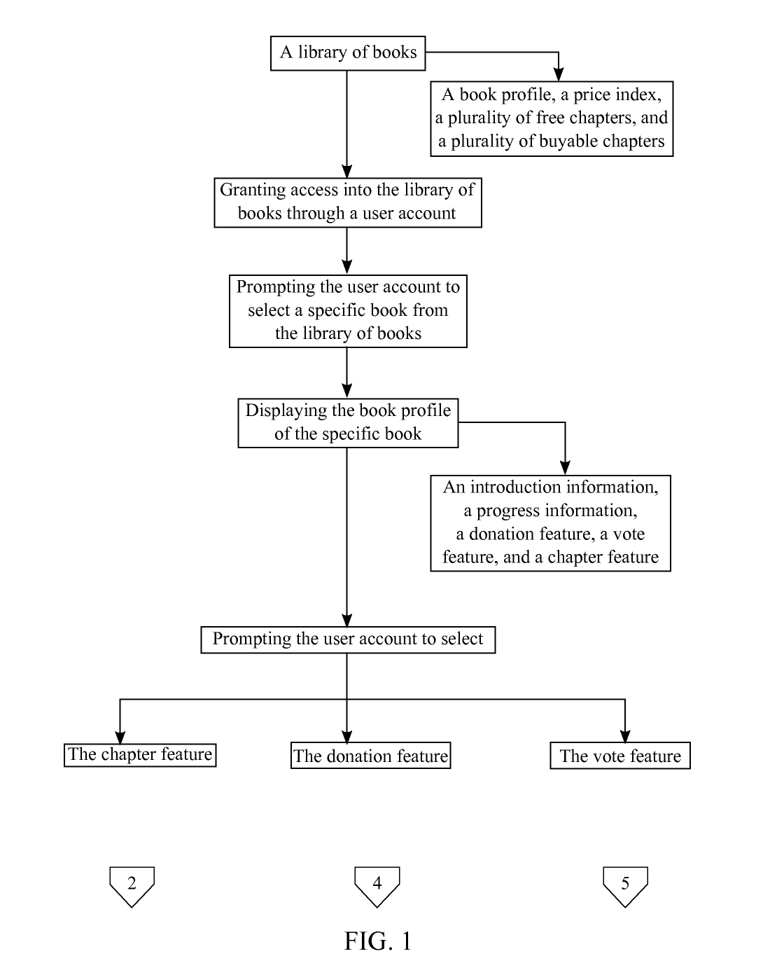

In reference to FIG. 1, once the control software finalizes the user account within the present invention, the user account is granted access into the library of books by the control software. Then the control software prompts the user account to selects a specific book from the library of books. In order to easily locate the specific book, the library of books is organized under many different categories and different genres. For example, the different categories that the library of books are organized under include, but are not limited to, star of the week, editor choices, good reads, best sellers, new arrivals, latest updates, and the author name. The different genres that the library of books are organized include, but are not limited to, romance, paranormal, history, spiritual, crime, media tie-in, dystopia, political, coming of age, mash up, and action. Once the user account selects the specific book, the book profile is displayed to the user account, wherein the book profile includes introduction information, a progress information, a donation feature, a vote feature, and a chapter feature.

The introduction information displays a brief description of the specific book to the user account through the book profile so that the user account is able to get an overall idea about the specific book. The brief description additionally displays a plurality of keywords that are related to the specific book, where the plurality of keyword enables the specific book to be easily identified through the search modules of the present invention.

The introduction information also displays a book title and an author name of the specific book within the book profile. The progress information that includes a total word count, a total user clicks, a total author clicks, and a timeline is displayed to the user account through the book profile. More specifically, the total word count indicates the total number of words for the specific book so that the user account can determine the amount of written material within the specific book. The total user clicks indicates how many of the other user accounts have shown interest in the specific book, where the user account is able to gauge the popularity of the specific book. The total author clicks indicates how active is the author of the specific book in relation to revisions, updates, and uploading new materials. The timeline displays the last incident that the author has worked on the specific book. Even though the introduction information and the progress information are displayed to the user account through the book profile, the control software prompts the user account to select either the donation feature, the vote feature, or the chapter feature of the specific book so that the user account can further interact within the present invention.

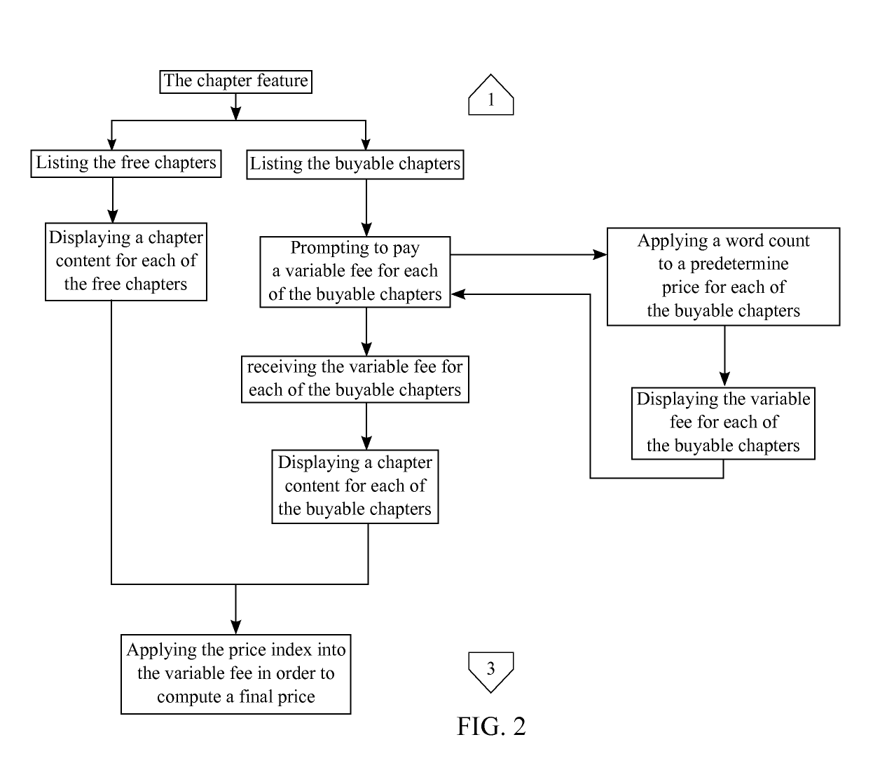

In reference to FIG. 2, if the user account selects the chapter feature, the control software lists the free chapters and the buyable chapters of the specific book to the user account. The free chapters and the buyable chapters are defined by the author of the specific book upon author's preference, where the user account is able to visually identify the difference between the free chapters and the buyable chapters within the chapter feature. More specifically, if the user account selects to view the free chapters, the control software displays a chapter content for each of the free chapters to the user account. Since the free chapters do not have any monetary value within the present invention, the user account can always view each of the free chapters without having to pay any kind of subscription fee. If the user account selects to view the buyable chapters, the control software prompts the user account to pay a variable fee for each of the buyable chapters. More specifically, the variable fee for each of the buyable chapters is calculated within the present invention as a word count for each of the buyable chapters is applied to a predetermined price for each of the buyable chapters. In other words, the word count is multiplied by the predetermined price for each of the buyable chapters in order to determine the variable fee for each of the buyable chapters. Generally, the word count and the predetermined price for the specific book are automatically assigned by the control software of the present invention, but the word count and the predetermined price can be respectively redefined as an author-defined word count and an author-defined price for the specific book upon author's discretion. For example, if the word count of one of the buyable chapter is 1000 words, and the predetermined price is 0.01 dollars for every 200 words, the variable fee of that specific buyable chapter is 0.05 dollars. After the variable fee for each of the buyable chapter is calculated by the control software, the variable fee is displayed to the user account. Then the control software displays the chapter content for each of the buyable chapters to the user account when the control software receives the variable fee for each of the buyable chapters from the user account. The chapter feature additionally allows the user account and the other user account to upload comments regarding the specific book. More specifically, the control software prompts the user account and the other user accounts to comment on the specific book through the chapter feature. Upon receiving personalized comments for the specific book through the chapter feature, the personalized comments are communally displayed to the user account and the other user accounts through the chapter feature.

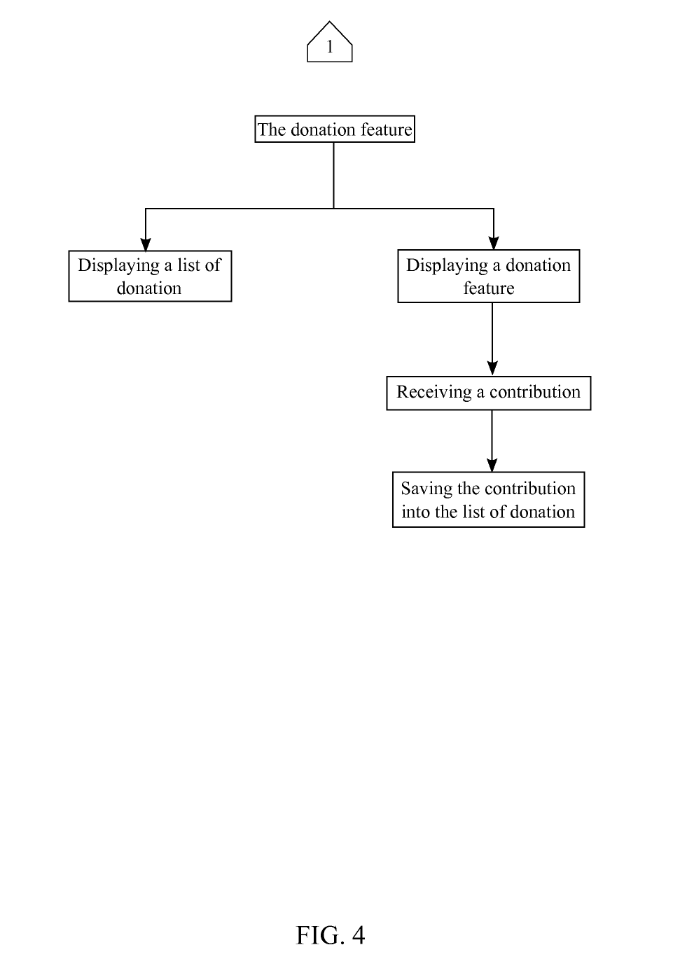

In reference to FIG. 4, a list of received donation and a donation feature are displayed to the user account through the donation feature of the book profile, where the donation feature greatly benefits and motivates the author of the specific book. More specifically, the user account can donate a contribution to the specific book through the donation feature if the user account desires. Upon receiving the contribution from the user account, the contribution is saved to the list of received donation and displayed within the list of received donation. The contribution of the present invention is not predetermined, where the user account can donate any desired amount as the contribution.

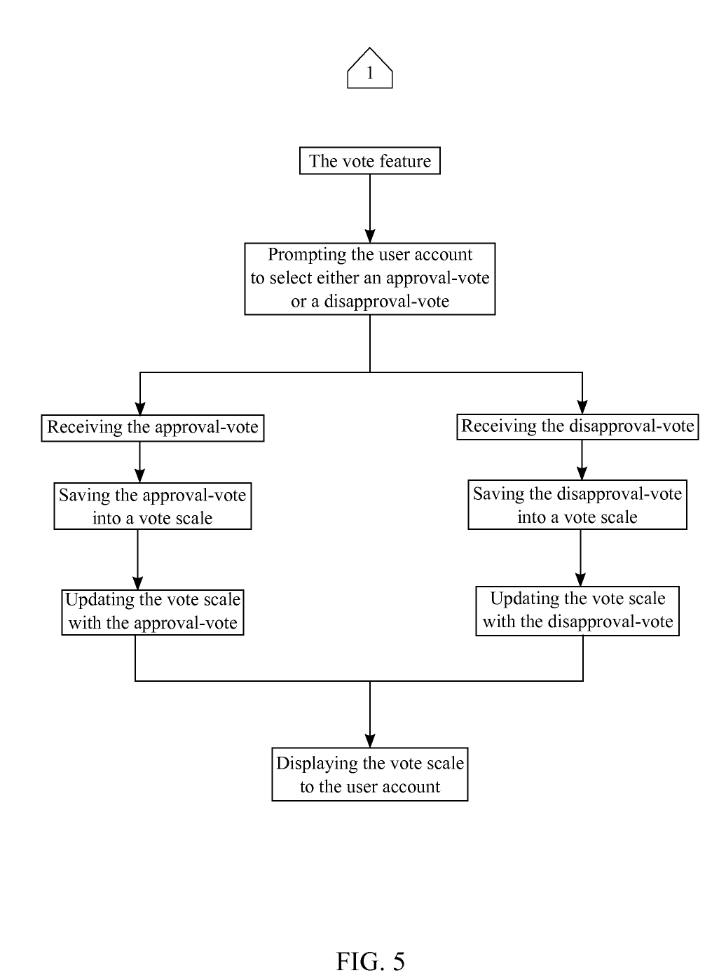

In reference to FIG. 5, the user account can also submit an approval-vote or a disapproval-vote through the vote feature with respect to the specific book. More specifically, the control software prompts the user account select either the approval-vote or the disapproval vote for the specific book. Then the user account is able to select in between the approval-vote or the disapproval-vote. If the user account selects the approval-vote, the approval-vote is received by the control software and saved into a vote scale of the vote feature so that the vote scale can be updated with the approval-vote. If the user account selects the disapproval-vote, the disapproval-vote is received by the control software and saved into the vote scale so that the vote scale can be updated with the disapproval-vote. After the approval-vote or the disapproval-vote is saved within the vote scale, the vote scale is displayed to the user account through the vote feature.

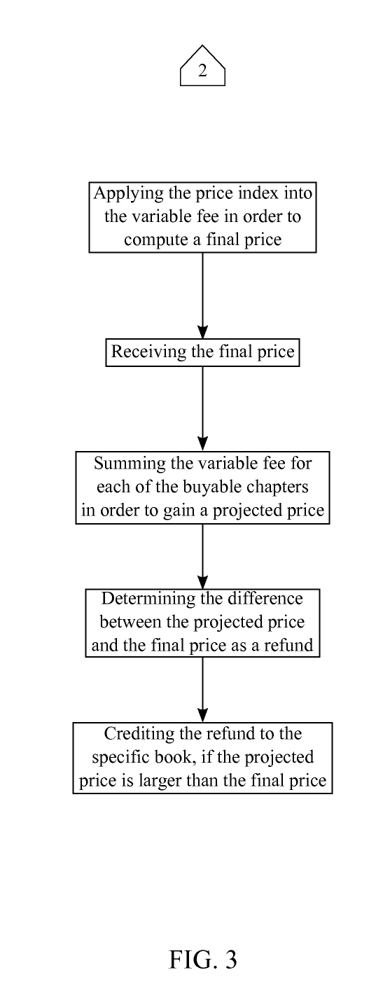

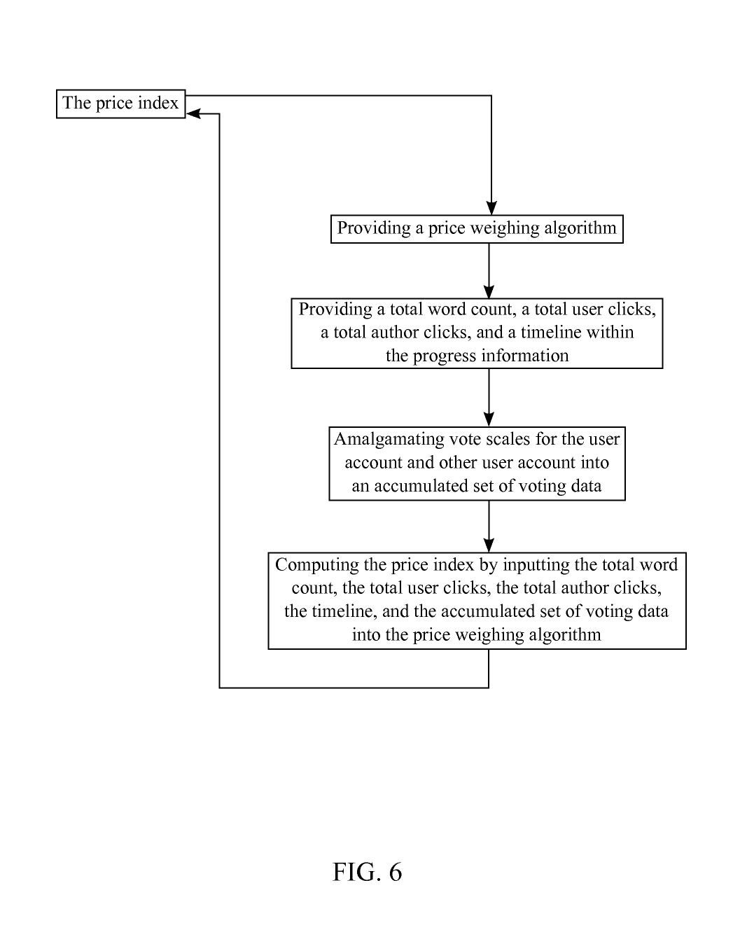

Once a completed version of the specific book is available to the user account through the present invention, the control software applies the price index into the variable fee for each of the buyable chapters in order to compute a final price for the specific book. In reference to FIG. 6, the price index is calculated through a price weighing algorithm by the control software only after the completed version for the specific book available, where the price weighing algorithm scales the variable fees of the specific book based on different performance factors. More specifically, the control software amalgamates the vote scales of the user account and the other user accounts into an accumulated set of voting data. Then the total word count, the total user clicks, the total author clicks, the timeline, and the accumulated set of voting data are inputted into the price weighing algorithm so that the control software can compute the price index. Since many different performance factors determine the price index of the specific book, the price index generally ranges from 0.5 to 1 in such way that 0.5 being the lowest index number and 1 being the highest index number. In reference to FIG. 3, once the correct index number is calculated through the price weighing algorithm, the variable fee for each of the buyable chapters is multiplied by the price index so that the final price for the specific book can compute through the present invention. After the final price is calculated within the present invention, the variable fee for each of the buyable chapters is summed together to gain a projected price of the specific book. In other words, the projected price is the total amount that the user account has paid for the specific book in order to read each of the buyable chapters. Then the control software determine a difference in between the projected price and the final price as a refund for the specific book if the projected price is larger than the final price. Then the refund is credited into the user account. For example, if the projected price is twenty dollars and the price index is 0.5 for the specific book, the final price of the specific book is ten dollars and the refund is ten dollars. The refund of the specific book provides an optimal consumer satisfaction through the present invention as the user account is partially able to control the final price of the specific book. Since some of the performance factors are individually related to each of the user accounts, the final price of the specific book differs from one user account to another, where each of the user accounts receives a customized final price for the specific book.

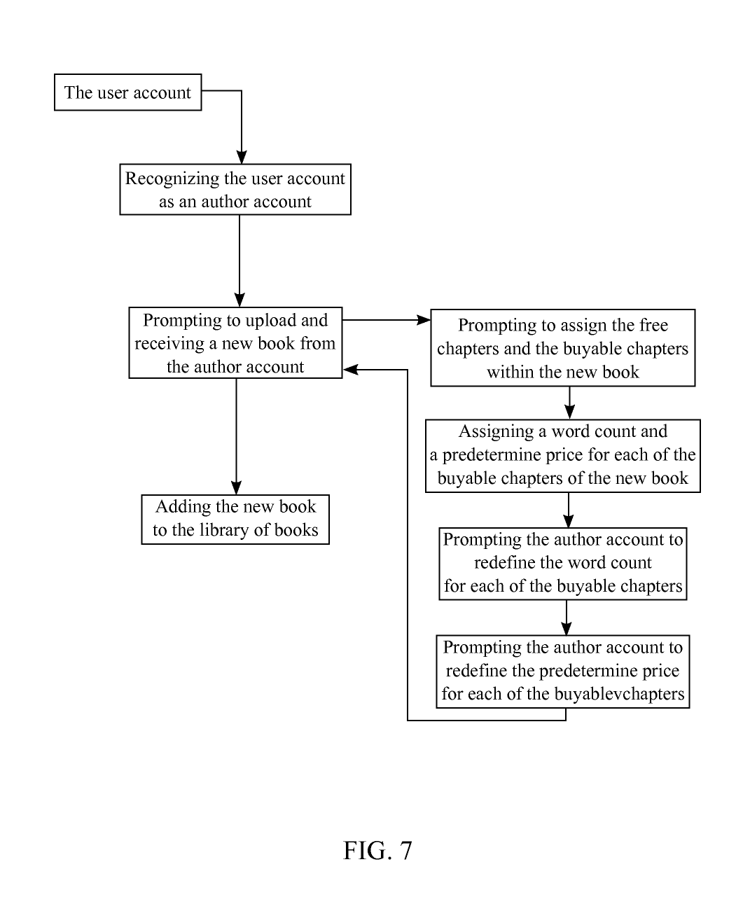

In reference to FIG. 7, the control software also recognizes the user account as an author account, where the author account is able to upload a new book. The control software first prompts the author account to upload the new book, where the new book can be uploaded as a complete version or an incomplete version. Then the control software receives the new book and adds the new book into the library of books. The control software also prompts the author account to assign the free chapters and the buyable chapters within the new book. Once the author account assigns the buyable chapters, the control software assigns the word count and the predetermined price for each of the buyable chapters of the new book. Then the author account has the option to redefine the word count and the predetermined price for each of the buyable chapters into the author-defined word count and the author-defined price, if the author account desires. The author account can also modify and revise the published free chapters and buyable chapters upon their preference. In the event of each of the buyable chapters is revised or modified by the author account, the variable fee for each of the buyable chapters does not change for the user accounts that have already purchased the buyable chapters; however the variable fee for each of the buyable chapters changes according to the revised or modified materials for the user accounts that have not purchased the buyable chapters. The present invention not only allows the author account to upload the new book either chapter by chapter or as the completed version, but the publishers can also evaluate the popularity of the new book compare to the library of books. As a result, the publishers can easily identify the high potentials of the new book and promote the new book based on the list of received donation, the accumulated set of voting data, the total user clicks, the total author clicks, and the timeline, etc.

Although the invention has been explained in relation to its preferred embodiment, it is to be understood that many other possible modifications and variations can be made without departing from the spirit and scope of the invention as hereinafter claimed.

What is claimed is:

1. A method for selling electronic books through a non-transitory computer-readable medium by executing computer-executable instruction comprises the steps of:
providing a library of books, wherein each of the library of books includes a book profile, a price index, a plurality of free chapters, and a plurality of buyable chapters;
granting access into the library of books through a user account;
prompting the user account to select a specific book from the library of books;
displaying the book profile of the specific book to the user account, wherein the book profile includes an introduction information, a progress information, a donation feature, a vote feature, and a chapter feature;
prompting the user account to select either the chapter feature, the donation feature, or the vote feature of the specific book;
listing the free chapters and the buyable chapters of the specific book to the user account,
if the user account selects the chapter feature;
displaying a chapter content for each of the free chapters to the user account,
if the user account selects to view the free chapters;
prompting the user account to pay a variable fee for each of the buyable chapters,
if the user account selects to view the buyable chapters;
displaying the chapter content for each of the buyable chapters to the user account,
if the variable fee is received for each of the buyable chapters;
applying the price index into the variable fee for each of the buyable chapters in order to compute a final price for the specific book,
if a completed version of the specific book is available to the user account;

2. The method for selling electronic books through a non-transitory computer-readable medium by executing computer-executable instruction as claimed in claim 1 comprises the steps of:
displaying a list of received donations and a donation feature on the book profile;
receiving a contribution from the user account,
if the user account selects the donation feature;
saving the contribution into the list of received donation of the specific book;

3. The method for selling electronic books through a non-transitory computer-readable medium by executing computer-executable instruction as claimed in claim 1 comprises the steps of:
prompting the user account to select either an approval-vote or a disapproval-vote through the vote features;
receiving either the approval-vote or the disapproval-vote for the specific book;

4. The method for selling electronic books through a non-transitory computer-readable medium by executing computer-executable instruction as claimed in claim 3 comprises the steps of:
saving the approval-vote into a vote scale of the vote feature,
if the user account selects the approval vote;
updating the vote scale with the approval-vote;
displaying the vote scale to the user account through the vote feature;

5. The method for selling electronic books through a non-transitory computer-readable medium by executing computer-executable instruction as claimed in claim 3 comprises the steps of:
saving the disapproval-vote into a vole scale of the vote feature,
if the user account selects the disapproval vote;
updating the vote scale with the disapproval-vote
displaying the vote scale to the user account through the vote feature;

6. The method for selling electronic books through a non-transitory computer-readable medium by executing computer-executable instruction as claimed in claim 1 comprises the steps of:
providing a word count and a predetermined price for each of the buyable chapters;
applying the word count to the predetermined price for each of the buyable chapters in order to compute the variable fee;
displaying the variable fee for each of the buyable chapters to the user account;

7. The method for selling electronic books through a non-transitory computer-readable medium by executing computer-executable instruction as claimed in claim 1 comprises the steps of:
receiving the final price;
summing the variable fee for each of the buyable chapters in order to gain a projected price of the specific book;
determining a difference between the projected price and the final price as a refund for the specific book,
if the projected price is larger than the final price;
crediting the refund into the user account;

8. The method for selling electronic books through a non-transitory computer-readable medium by executing computer-executable instruction as claimed in claim 1 comprises the steps of:
providing a price weighing algorithm, wherein the price weight algorithm scales the variable fee based on performance factors of the specific book;
providing a total word count, a total user clicks, a total author clicks, and a timeline within the progress information;
amalgamating vote scales for the user account and other user accounts into an accumulated set of voting data;
computing the price index by inputting the total word count, the total user clicks, the total author clicks, the timeline, and the accumulated set of voting data into the price weighing algorithm;

9. The method for selling electronic books through a non-transitory computer-readable medium by executing computer-executable instruction as claimed in claim 1 comprises the steps of:
recognizing the user account as an author account;
prompting to upload and receiving a new book from the author account;
adding the new book to the library of books;

10. The method for selling electronic books through a non-transitory computer-readable medium by executing computer-executable instruction as claimed in claim 9 comprises the steps of:
prompting the author account to assign the free chapters and the buyable chapters within the new book;
assigning a word count and a predetermined price for each of the buyable chapters of the new book;
prompting the author account to redefine the word count for each of the buyable chapters of the new book;
prompting the author account to redefine the predetermined price for each of the buyable chapters of the new book;

11. The method for selling electronic books through a non-transitory computer-readable medium by executing computer-executable instruction as claimed in claim 1 comprises:
prompting the user accounts and other user accounts to comment on the specific book through the chapter feature;
receiving personalized comments for the specific book through the chapter feature;
communally displaying the personalized comments to the user account and the other user accounts;
